(19) United States
(12) Patent Application Publication
(10) Pub. No.: US 2005/0016108 A1
(43) Pub. Date: Jan. 27, 2005

(54) Lightweight construction element and method for producing the same

(76) Inventors: Karl-Heinz Lindner, Muelheim (DE); Alf Birkenstock, Heiligenhaus (DE); Jurgen Baumgarten, Wuppertal (DE); Bernd Fausten, Castrop-Rauxel (DE)

Correspondence Address: KATTEN MUCHIN ZAVIS ROSENMAN, 575 MADISON AVENUE, NEW YORK, NY, 10022-2585, US

(21) Appl. No.: 10/483,897

(22) PCT Filed: Feb. 26, 2003
(86) PCT No.: PCT/EP03/01936

(30) Foreign Application Priority Data
May 31, 2002 (DE) 102 24 198.8

(51) Int. Cl. B62D 29/00

(52) U.S. Cl. 52/633

(57) ABSTRACT

The invention relates to a lightweight construction element having an inner framework structure of light metal composed of a plurality of extruded hollow sections (1, 2, 3) joined to one another in a flat configuration, the lightweight construction element having a circumscribed circle with a diameter of at least 300 mm and a wall thickness of at most 0.5% of this value.

The present invention relates to a lightweight construction element having an inner framework structure of light metal. The invention also relates to a method for producing the lightweight construction element.

The use of light metals is one of the greatest challenges in the construction of locomotion means, especially automobiles, since minimization of weight is one of the most effective methods of reducing fuel consumption.

Against the background of a cost-to-benefit comparison of different light metals, it is clear that the manufacturing costs increase drastically with increasing weight savings by the use of such materials. Thus lightweight construction can only be achieved economically if it becomes possible to compensate for the associated higher material costs by more favorable production processes and in particular by more sparing use of materials.

Lightweight construction elements having an inner framework structure of light metal material have proved advantageous for the purpose of the best possible ratio between weight and load-bearing ability or strength. Such lightweight construction elements can be produced economically by extrusion.

As regards the extrusion process, however, the relative ratio between the size of the section to be pressed and the size of the extrusion press and especially of the chamber diameter is critical for the material flow of a given material. For example, from the Aluminum Textbook published by Aluminium-Verlag of Düsseldorf, 15^{th} Edition 1996, Vol. 2, p. 103, it is known that, in the extrusion of hollow sections made of pure aluminum or of AlMgSi alloys and having uniform wall thickness, a section having a section circle diameter of 450 mm and obtained by extrusion in an 80-MN extrusion press can have a minimum wall thickness of 5 mm, whereas a section having a section circle diameter of 50 mm and obtained by extrusion in a 10-MN extrusion press can have a minimum wall thickness of 1 mm. This shows that large lightweight construction elements can be produced only with relatively thick wall thicknesses by extrusion, meaning higher production costs and, because of the greater component weight, also a negative influence on the fuel consumption of a vehicle containing this component.

Against this background, the object of the present invention is to provide a lightweight construction element having an inner framework structure of light metal, wherein the wall thickness is smaller than in conventional lightweight construction elements produced by extrusion.

This object is achieved according to the invention by the fact that there is taught a lightweight construction element having an inner framework structure of light metal, comprising a plurality of extruded hollow sections joined to one another, the lightweight construction element having a circumscribed circle with a diameter of at least 300 mm and a wall thickness of at most 0.5% of this value. In a particularly preferred embodiment of the invention, the wall thickness is at most 0.35% of the diameter of the circumscribed circle of the lightweight construction element.

According to the invention, therefore, by extruding individual hollow sections and joining the hollow sections in a planar configuration, there can be obtained a lightweight construction element of practically any desired size with a wall thickness, which construction element, because of the technical limitations of the extrusion process, cannot be manufactured in monolithic form or can only be manufactured with much greater linear density or greater wall thickness once its size exceeds a certain value (generally a circumscribed circle with a diameter of larger than 300 mm).

As the Applicant has surprisingly found, the extruded hollow sections of the inventive lightweight construction element can be joined by friction stir welding. Heretofore those skilled in the art have assumed that the friction stir welding technique requires that the workpieces to be welded each have a wall thickness of at least 1.6 mm (most recently stated in a contribution by the Alusuisse Co. at the 2^{nd} Technical Conference on “Advances in Lightweight Automotive Engineering”, Stuttgart, 6 to 7 Nov. 2001). Friction stir welding (FSW) had already been developed almost ten years ago (see European Patent B 0615480). Nevertheless, it is not yet one of the standard joining techniques in the automobile industry, where only resistance welding, inert-gas welding and laser (hybrid) welding have been used heretofore as thermal joining techniques.

It is particularly advantageous in friction stir welding—in contrast to conventional welding techniques—that welding of the two workpieces takes place below the liquidus temperature of the materials to be welded, and so no appreciable risk of development of pores and hot cracks exists. Moreover, even alloys that are difficult or impossible to melt as well as aluminum/magnesium composite elements can be welded with friction stir welding, an accomplishment that is difficult or even impossible with the conventional welding techniques. Thus entirely new possibilities for the production of composite components are created by the friction stir welding technique.

As an alternative to friction stir welding, the individual hollow sections can be joined by adhesive bonding, which has the advantage in particular that the hollow sections to be joined are subjected to only slight thermal stress, whereby development of pores and hot cracks is avoided.

To ensure that the hollow sections composing the lightweight construction element can be joined, they can be provided with appropriate elements in the form of ridges, hooks or grooves, so that the elements in the form of ridges, hooks or grooves of adjacent hollow sections have corresponding shape and can overlap in a planar configuration of the hollow sections, in order to be able, together with the adjacent zones of the sections, to withstand the forces occurring during friction stir welding.

As an alternative to this, it may also be possible to avoid the use of hollow-section elements in the form of ridges, hooks or grooves, in which case the hollow sections are joined only along an abutting edge. To ensure that no deformations of the hollow sections are caused during friction stir welding, the forces occurring at this time must be absorbed by an appropriate fixture, such as an inner mandrel. Avoiding the use of elements in the form of ridges, hooks or grooves can be regarded as advantageous, since this contributes to economy of materials and thus to reduction of costs and weights.

The individual hollow sections may be made of aluminum, magnesium, titanium or alloys thereof. By joining hollow sections of dissimilar materials, it is advantageously possible to produce composite members.

In a particularly advantageous embodiment of the invention, a lightweight construction element comprises a plurality of mutually symmetric, individual hollow sections. Hereby the costs of producing a lightweight construction element can be greatly reduced by a smaller number of tools and simplified logistics.

For production of the inventive lightweight construction element, hollow sections with a wall thickness of at most 0.5% of the diameter of the circumscribed circle of the lightweight construction element manufactured therefrom are produced by extrusion. The extruded hollow sections are then joined in a planar configuration to form a lightweight construction element, in such a way that the lightweight construction element has a circumscribed circle having a diameter of at least 300 mm. Friction stir welding and adhesive bonding are preferably used for joining the hollow sections.

The inventive lightweight construction element produced in this way is preferably used as part of a load-bearing structure, for example in a motor vehicle.

The invention will now be explained in more detail on the basis of practical examples with reference to the attached drawings, wherein

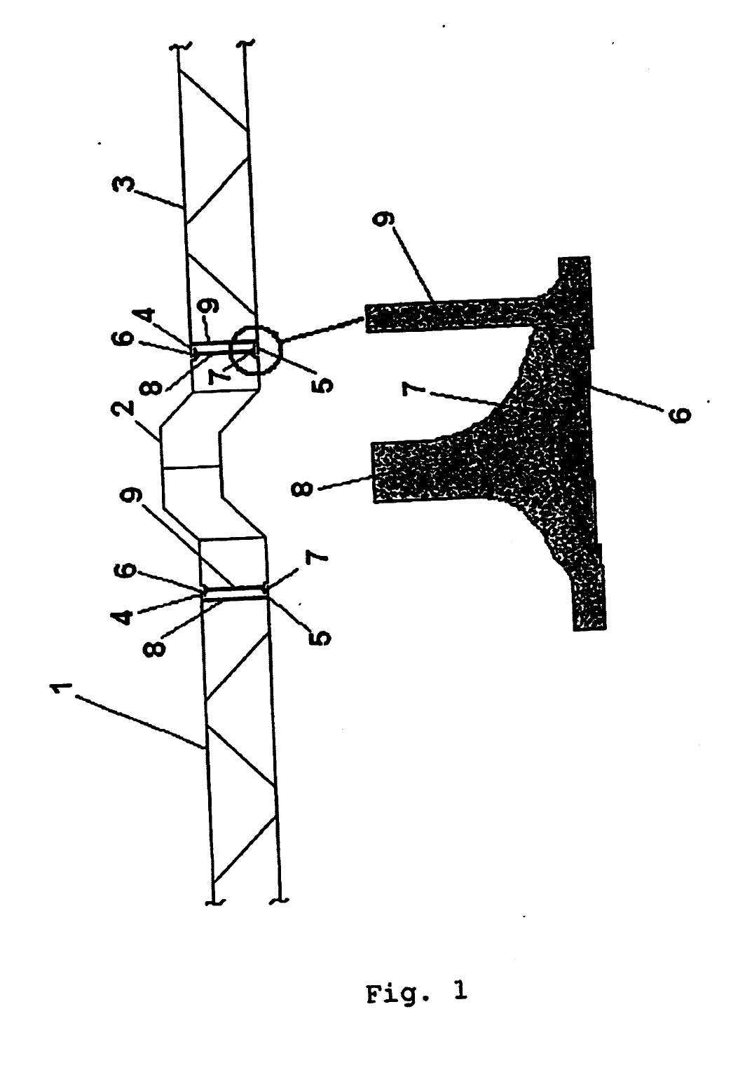

FIG. 1 shows a sectional view of an inventive lightweight construction element having an inner framework structure comprising three joined individual hollow sections;

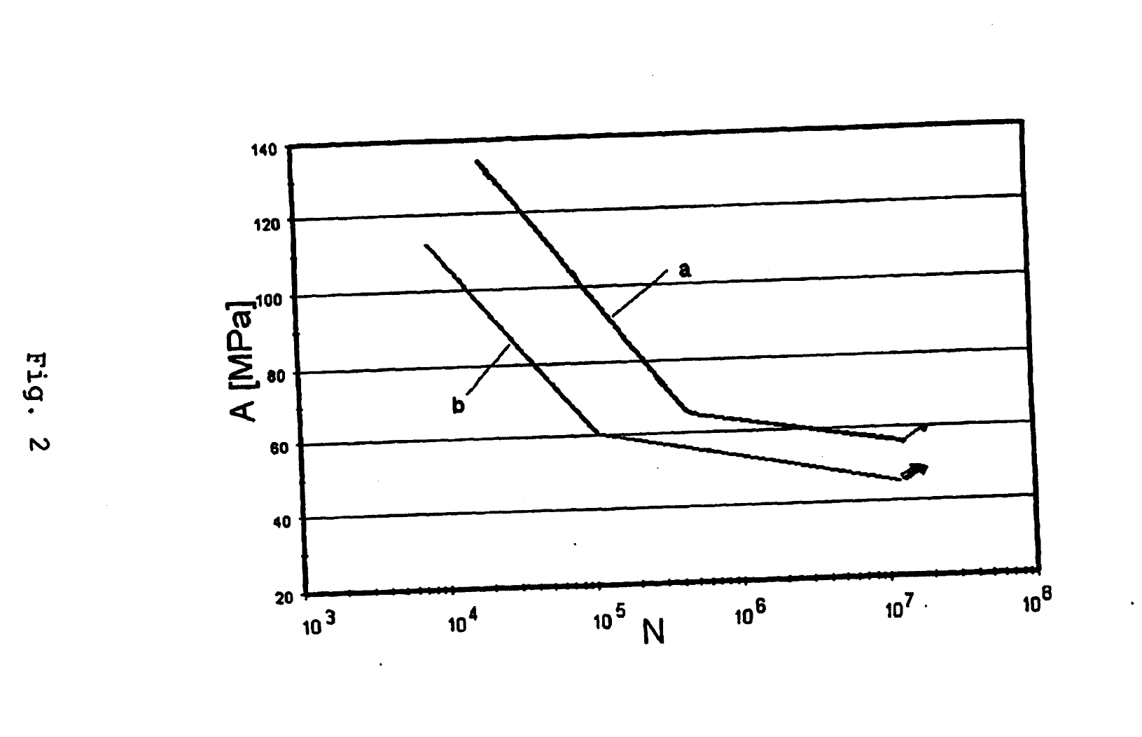

FIG. 2 shows, in the form of a Wöhler diagram, the behavior of the stress amplitude A [MPa] as a function of the number N of load cycles of a lightweight construction element manufactured by friction stir welding (curve a) and by laser welding (curve b);

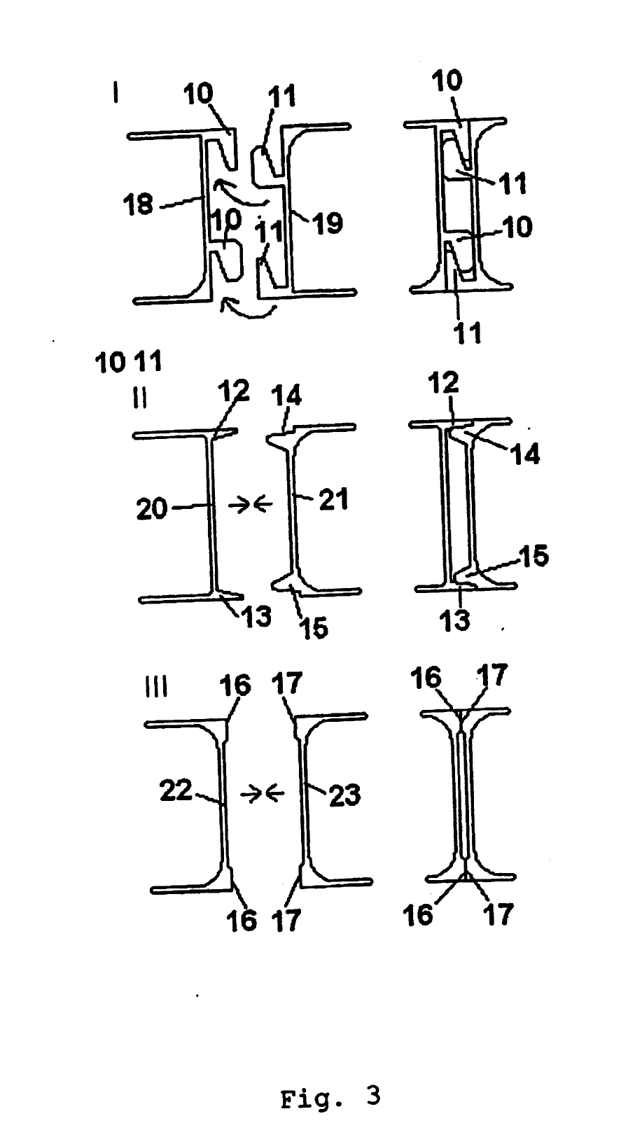

FIG. 3 shows examples of the joining points of adjacent hollow sections.

Referring first to FIG. 1, wherein there is illustrated a sectional view of an inventive lightweight construction element having an inner framework structure, the lightweight construction element is composed of three hollow sections 1, 2, 3 in a planar configuration. The two outer hollow sections 1, 3 have mutually symmetric shape, in that one of the two hollow sections has merely been rotated by 180° around its longitudinal axis relative to the other hollow section. The two outer hollow sections 1, 3 are provided with ridge-shaped connecting elements 4, 5, while middle hollow section 2 is provided with ridge-shaped connecting elements 6, 7 of shape complementary thereto. During joining of the hollow sections, the ridge-shaped connecting elements of adjacent hollow sections are brought into mutual contact and are joined by techniques such as friction stir welding. The forces developed during friction stir welding are absorbed by the ridge-shaped connecting elements and the zones 8, 9 of the hollow sections adjacent to them, whereby undesired deformations of the hollow sections can be avoided. The enlarged detail shows how ridge-shaped connecting elements 6, 7 of the two hollow sections 2, 3 are brought into contact via their complementary shapes.

The lightweight construction element illustrated as an example in FIG. 1 is made of aluminum hollow sections and, for a wall thickness of about 1 mm, has a circumscribed circle with a diameter of about 500 mm. The joined individual hollow sections have a circumscribed circle with a diameter of about 170 mm.

By comparison with the manufacture of a corresponding lightweight construction element from two equally large individual hollow sections (circumscribed circle with a diameter of about 250 mm), in which case the wall thickness achievable by the extrusion technique was 2 mm and the individual hollow sections were welded together by laser welding, the weight savings achieved in the inventive lightweight construction element was about 15%.

In a particularly advantageous manner, the endurance limit of the lightweight construction element produced can be greatly increased in the case of hollow sections joined by friction stir welding. For comparison of the endurance limit of lightweight construction elements produced by laser welding and by friction stir welding, appropriately manufactured lightweight construction elements were subjected to a sinusoidally increasing and decreasing tensile stress at various load levels. The result is illustrated in FIG. 2, which shows, in the form of a Wohler diagram, the behavior of the stress amplitude A [MPa] versus the number N of load cycles of similar lightweight construction elements manufactured by friction stir welding (curve a) and by laser welding (curve b).

As is evident from FIG. 2, a laser-welded lightweight construction element subjected to a high load level of 75 MPa can be expected to fail already at about 33,000 load cycles, whereas such failure is not expected until about 240,000 load cycles in the case of a friction-stir-welded lightweight construction element. For high load, therefore, this means that the stress and strain endurance of the friction-stir-welded lightweight construction element is about 7.4 times greater than that of the laser-welded lightweight construction element. For the case of a low load level of 47 MPa, failure of the laser-welded lightweight construction element takes place at about 2 million load cycles, whereas it does not occur until about 5 million load cycles in the friction-stir-welded lightweight construction element. For low load, therefore, this means that the stress and strain endurance of the friction-stir-welded lightweight construction element is about 2.5 times greater than that of the laser-welded lightweight construction element.

It is also evident that a fracture of the laser-welded lightweight construction element is generally located in the weld, starting from the upper side of the weld and from hydrogen pores, whereas fractures of the friction-stir-welded lightweight construction element are located in the base metal and start from notches in the section, or in other words extrusion marks or surface irregularities.

FIG. 3 shows, in sectional view, various shapes of joining points of the hollow sections. The hollow sections shown in Case I are each provided with hook-shaped connecting elements 10, 11 of corresponding shape. To join the hollow sections, the hook-shaped connecting elements are engaged in one another (right diagram) and then are joined at the contact faces, for example by friction stir welding. The mechanical pressure forces exerted by the welding mandrel on the hollow sections are absorbed by hook-shaped connecting elements 10, 11 and the adjacent zones 18, 19 of the sections, thus counteracting deformation of the hollow sections.

In Case II of FIG. 3, one hollow section is provided with the ridge-like, terrace-shaped connecting elements 12, 13, while the hollow section to be joined thereto is provided with ridge-like connecting elements 14, 15 having a terrace shape corresponding thereto. To join the hollow sections, the ridge-like connecting elements are brought into contact with one another and then are joined at the contact faces, for example by friction stir welding. The pressure forces exerted on the hollow sections during friction stir welding are absorbed by the terrace-shaped connecting elements and the adjacent zones 20, 21 of the sections.

In Case III of FIG. 3, the hollow sections are provided with flat abutting faces 16, 17 of corresponding shape. For joining, the abutting faces 16, 17 are brought up against one another and joined at the contact faces. The pressure forces acting on the sections during friction stir welding must be absorbed by an appropriate fixture, such as an inner mandrel, in order to prevent deformations of the hollow sections.

1. A lightweight construction element having an inner framework structure of light metal, comprising a plurality of extruded hollow sections joined to one another in a planar configuration, the lightweight construction element having a circumscribed circle with a diameter of at least 300 mm and a wall thickness of at most 0.5% of this value.

2. A lightweight construction element according to claim 1, characterized in that the wall thickness is at most 0.34% of the diameter of the circumscribed circle of the lightweight construction element.

3. A lightweight construction element according to claim 1, characterized in that the wall thickness of the lightweight construction element is 1.5 mm.

4. A lightweight construction element according to claim 1, characterized in that the wall thickness of the lightweight construction element is 1 mm.

5. A lightweight construction element according to claim 1, in which the hollow sections are joined by friction stir welding.

6. A lightweight construction element according to claim 1, in which the individual hollow sections are joined by adhesive bonding.

7. A lightweight construction element according to claim 1, in which the hollow sections are provided with a connecting element having the form of ridges, hooks or grooves suitable for absorbing the forces occurring during joining.

8. A lightweight construction element according to claim 1, in which the hollow sections are made of aluminum, magnesium, titanium or alloys thereof.

9. A lightweight construction element according to claim 8, in which the hollow sections are made of dissimilar light metals or light-metal alloys.

10. A lightweight construction element according to claim 1, composed of mutually symmetric individual hollow sections.

11. A method for producing a lightweight construction element according to one of the preceding claims and comprising the following steps:
(a) extrusion of hollow sections with a wall thickness of at most 0.5% of the diameter of the circumscribed circle of the lightweight construction element manufactured therefrom,
(b) joining of a plurality of hollow sections in a planar configuration to form a lightweight construction element, which has a circumscribed circle with a diameter of at least 300 mm.

12. A method according to claim 11, in which the hollow sections are joined by friction stir welding.

13. A method according to claim 11, in which the hollow sections are joined by adhesive bonding.
